(19) United States
(12) Patent Application Publication
(10) Pub. No.: US 2026/0064363 A1
(43) Pub. Date: Mar. 5, 2026

(54) DATA MERGING USING A SINGLE FEED-FORWARD DATA PATH BETWEEN CONSECUTIVE DATA PROCESSING STAGES

(71) Applicant: NVIDIA Corporation, Santa Clara, CA (US)

(72) Inventors: Niall Emmart, Amherst, MA (US); Michael Alan Fetterman, Lancaster, MA (US); Duane George Merrill, III, Charlottesville, VA (US)

(21) Appl. No.: 18/818,422

(22) Filed: Aug. 28, 2024

(51) Int. Cl. G06F 7/16

(52) U.S. Cl. CPC G06F 7/16

(57) ABSTRACT

Sorting data in memory is a fundamental computation that facilitates a wide range of search and query problems, aids in the construction and manipulation of data structures, and can improve the spatial and temporal locality of data and computation. Oftentimes, merge-based designs are used for sorting data, where a block sorting pass is performed followed by merging passes that produce increasingly larger sorted sublists until only a single list remains. While conventional merge-based designs can support multiple (K) merge operations in a single pass, a balance must be struck since there exists a point where K-scaling is no longer profitable. The present disclosure provides an alternative merge-based design in which data is merged using a single feed-forward data path.

### TECHNICAL FIELD

The present disclosure relates to processes and architectures for merging data.

### BACKGROUND

Sorting is a fundamental computation that facilitates a wide range of search and query problems, aids in the construction and manipulation of data structures, and can improve the spatial and temporal locality of data and computation. These sorting problems are representative of database query processing, genomic analysis, signal processing, 3D ray/path tracing, and other high throughput applications. Dedicated processing units for such sorting workloads are often merge-based designs that make streaming passes through the dataset. Conventional merge sorting is bootstrapped with a block sorting pass, followed by merging passes that produce increasingly larger sorted sublists until only a single list remains. Merging exposes numerous opportunities for structured parallelism and is well suited to both fixed-function hardware as well as the Single Instruction/Multiple Data (SIMD) programming environments of central processing unit (CPU) and graphics processing unit (GPU) processor cores.

When merging, an important consideration is the number of lists being merged in a single pass, or in other words the “way” of the merge. Streaming tournaments are mechanisms for K-way merging. Relative to 2-way merging, K way merging reduces the total number of passes through memory by a factor of log₂K. When these passes are memory-bound, the overall merging time is similarly reduced. The amount of tournament state, however, scales at least O(K) for any design that loads each value only once. Furthermore, as K increases, utilization issues can cause tournaments to become compute and/or latency bound. Consequently, there exists a point where K-scaling is no longer profitable, i.e., either (a) the increasing resource costs no longer justify the corresponding reduction in merging passes, or (b) the aggregate run time begins to outpace the reduction in passes.

Conventional tournaments are logically organized as parallel merge trees (PMTs). Keys are dequeued from memory into the leaves of the tree and percolate through merge nodes towards the root. For maximal throughput, it is common for hardware-based PMTs to implement one merging facility per node. The workload balance of these facilities, however, is poor in the presence of distribution skew, i.e., the degree and scale to which the input lists are non-overlapping in value. Skewed distributions induce periods of biased merge node consumption where the active nodes are advancing keys from only one of their input channels. Prolonged bias can severely hinder throughput, especially within vector-decimated PMTs having narrower data paths at the leaves. In the extreme, the input lists may not overlap at all. The dynamic nature of key advancement has given rise to internal PMT channels with deep buffering, backpressure/demand signaling, rate converters, and other flow management overheads. Even with these accommodations, distribution skew is such a concern that many PMTs expect their inputs to have been randomly permuted prior to merging.

Furthermore, tournament-level parallelism is increasingly desirable. Modern processors and their memory hierarchies are becoming wider and deeper, and a single processing element is often insufficient for saturating memory bandwidth. As examples, a single GPU thread cannot saturate its L1 cache bandwidth, and a single GPU core is unable to saturate the GPU's L2 bandwidth. Consequently, high-throughput merging within these computing environments can require a sizable number of parallel tournaments computing disjoint mergers partitioned from the current merging pass.

Today, however, it is uncommon to scale merging across multiple PMTs. Their cost/benefit proposition is relatively expensive due to their flow management overheads and their inefficient use of underlying merge facilities. Furthermore, differing skew distributions between equal-sized subproblems can lead to runtime variance among PMT instances. This results in system-wide underutilization when the next sorting pass is dependent on some PMTs that run longer than others.

There is a need for addressing these issues and/or other issues associated with the prior art. For example, there is a need to merge data using a single feed-forward data path, which is capable of being unaffected by distribution skew, is capable of having reduced implementation overheads, and is capable of allowing for disaggregated staging.

### SUMMARY

A method, computer readable medium, and system are disclosed to merge data using a single feed-forward data path between consecutive stages. At least three sorted data sequences are merged using a cascade of data processing stages, wherein consecutive stages in the cascade of data processing stages are connected by a single feed-forward data path and wherein output of each data processing stage in the cascade of data processing stages includes two or more data elements in a sorted order. A result of the merging is output.

### BRIEF DESCRIPTION OF THE DRAWINGS

FIG. 1 illustrates a flowchart of a method for merging data using a single feed-forward data path between consecutive stages, in accordance with an embodiment.

FIG. 2 illustrates pipeline architecture for merging data that includes a single feed-forward data path between consecutive stages, in accordance with an embodiment.

FIG. 3 illustrates an exemplary implementation of the pipeline architecture of FIG. 2, in accordance with an embodiment.

FIGS. 4A-4S illustrate a state of the pipeline architecture of FIG. 3 during a merge process, in accordance with an embodiment.

FIG. 5 illustrates a method for merging data for use by a downstream task, in accordance with an embodiment.

FIG. 6 illustrates a network architecture, in accordance with an embodiment.

FIG. 7 illustrates an exemplary system, in accordance with an embodiment.

### DETAILED DESCRIPTION

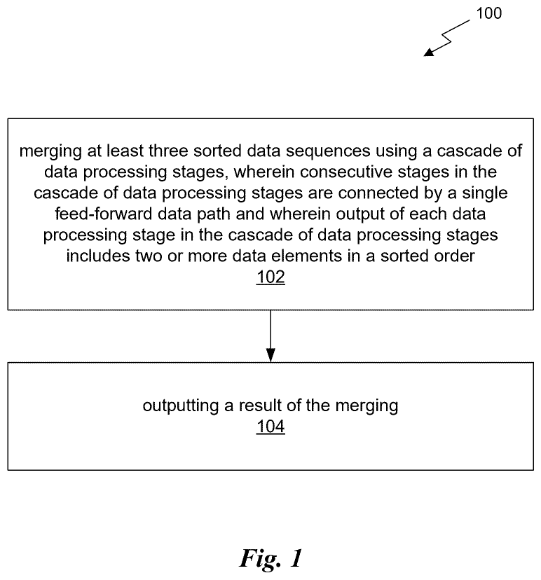

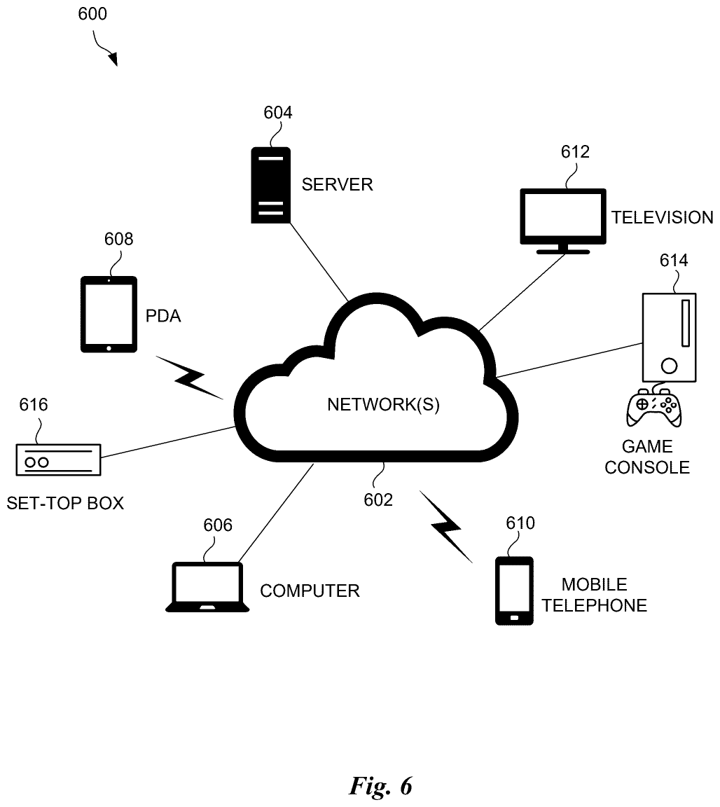

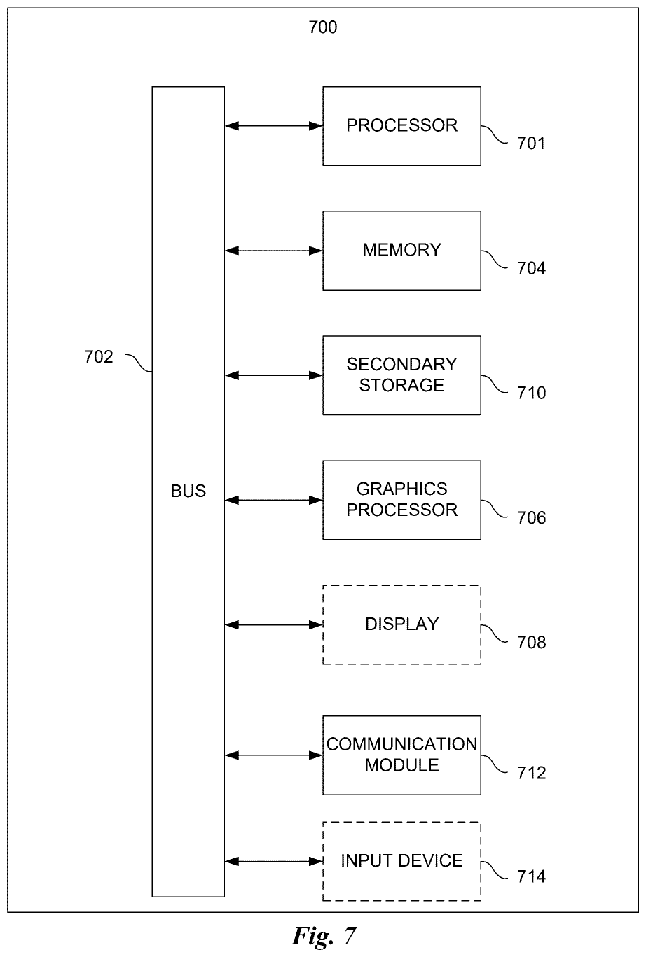

FIG. 1 illustrates a flowchart of a method 100 for merging data using a single feed-forward data path between consecutive stages, in accordance with an embodiment. The method 100 may be performed by any device, such as a processing unit, a program, custom circuitry, or a combination thereof. For example, the method 100 may be executed by a GPU (graphics processing unit), CPU (central processing unit), or any processor described below. As another example, the method 100 may be performed in the context of the devices in the network architecture 600 of FIG. 6 and/or in the context of the system 700 of FIG. 7.

In an embodiment, the method 100 may be performed in software executing on a device. In another embodiment, the method 100 may be performed in hardware of a device. Persons of ordinary skill in the art will understand that any system that performs method 100 is within the scope and spirit of embodiments of the present disclosure.

In operation 102, at least three sorted data sequences are merged using a cascade of data processing stages. With respect to the present description, the merging is performed in accordance with a defined order. The defined order may be an ascending order, a descending order, a customized ordering that is defined at the time the device performing the method 100 is instantiated, or a customized ordering that is defined at the time the device performing the method 100 is invoked.

Each of the sorted data sequences is a sequence of data elements that have been sorted in accordance with the defined order. In an embodiment, the sorted data sequences may be generated from a dataset of unsorted data elements stored in memory. For example, the dataset of unsorted data elements may be divided in at least three buckets, with each bucket of data elements then sorted to form a respective one of the sorted data sequences. The data elements may be of any type. For example, the data elements may be integer values.

In an embodiment, the sorted data sequences may be held in a dequeue stage. The sorted data sequences may be input from the dequeue stage to a first data processing stage in the cascade of data processing stages. In an embodiment, a number of the sorted data sequences may correspond to a number of buffers used by the dequeue stage. In an embodiment, the dequeue stage may be decoupled from the cascade of data processing stages. For example, the dequeue stage may be located within a memory system whereas the cascade of data processing stages may be located within at least one processing core.

In the context of the present description, the cascade of data processing stages refers to a plurality of data processing stages where consecutive stages in the cascade of data processing stages are connected by a single feed-forward data path and where output of each data processing stage in the cascade of data processing stages includes two or more data elements in a sorted order (i.e. per the defined order). In an embodiment, at least two of the data processing stages in the cascade of data processing stages may be located within different processor cores. In another embodiment, all of the data processing stages in the cascade of data processing stages may be located within different processor cores. In yet another embodiment, at least two of the data processing stages in the cascade of data processing stages may be located within a same processor core. In still yet another embodiment, all of the data processing stages in the cascade of data processing stages may be located within a same processor core.

At each time step in the merging process, the dequeue stage may input a different portion of one of the at least three sorted data sequences to a first data processing stage in the cascade of data processing stages. Each different portion that is input to the first data processing stage may be a vector of sorted data elements. For example, a plurality of vectors of sorted data elements (each representing a portion of a corresponding one of the sorted data sequences) may be stored in a plurality of first-in-first-out (FIFO) buffers of the dequeue stage. The sorted data sequences may be generated from a prior merger or prior bootstrapping process and may be apportioned from memory into the FIFO buffers as space in the FIFO buffers becomes available, namely when a vector of data elements is transferred from one of the FIFO buffers to the first data processing stage.

For example, at each time step in the merging process, one of the plurality of vectors of sorted data elements may be selected for being input to the first data processing stage. This selection may be made by comparing a data element at a head of each vector of the plurality of vectors against a data element at a head of each other vector in the plurality of vectors and choosing the vector with a data elements at its head that wins those comparisons (i.e. based on the defined order).

Further, each data processing stage in the cascade of data processing stages may merge a received input with a locally stored sorted data sequence and may output a result. In an embodiment, each data processing stage in the cascade of data processing stages may locally store at least one sorted data sequence. At least the first data processing stage in the cascade of data processing stages may select the locally stored sorted data sequence from among a plurality of locally stored sorted data sequences, for merging with the received input. Then, in an embodiment, a first portion of the result of the merge at the data processing stage may be output forward through the single feed-forward data path and a second portion of the result may be stored locally by the data processing stage.

For example, at the next time step following the selection of one of the of sorted data elements plurality of vectors to be input to the first data processing stage, one of the plurality of locally stored sorted data sequences may be selected for being merged with the received input. This selection may be made by comparing a data element at a head of each locally stored sorted data sequence of the plurality of locally stored sorted data sequences with a data element at a head of each other locally stored sorted data sequence of the plurality of locally stored sorted data sequences and choosing the one of the plurality of locally stored sorted data sequences with a data element at its head that wins those comparisons (i.e. based on the defined order). Further to this example, the first data processing stage may then merge the received input with the selected locally stored sorted data sequence to generate a result, output a first portion of the result forward through the single feed-forward data path to the second data processing stage and locally store a second portion of the result.

In operation 104, a result of the merging is output. With respect to the present description, the result of the merging is a single sequence of data elements. Further, the data elements in the single sequence may be sorted (i.e. in accordance with the defined order).

In an embodiment, the result of the merging may be output to a downstream task. For example, the downstream task may require, or may at least be benefited by, the data elements in the dataset being merged and sorted in a single sequence. In an embodiment, the downstream task may use the result of the merging to perform ray-tracing. In an embodiment, the downstream task may use the result of the merging to perform genomic analysis. In an embodiment, the downstream task may use the result of the merging to perform database query processing. In an embodiment, the downstream task may use the result of the merging to perform signal processing.

To this end, the method 100 may employ the single feed-forward data path (e.g. channel) between consecutive data processing stages for merging at least three sorted data sequences. In an embodiment, this single feed-forward data path provides an alternative to conventional merge-sort solutions that rely on parallel merge trees (PMTs) that provide a hierarchical approach to merging. Compared with PMT designs, the linear structure of the single feed-forward data path requires less flow management, is more resilient to performance variance and hardware underutilization from skewed key distributions, and facilitates the physical disaggregation of data processing stages.

In an embodiment, the single feed-forward path may operate at a constant flow rate. In an embodiment, each data processing stage in the cascade of data processing stages may be implemented using a single merge unit. For example, each data processing stage in the cascade of data processing stages may be implemented as a virtualized instance of the single merge unit. In an embodiment, the merge unit may be a fixed network of binary comparators. In an embodiment, the single feed-forward path is implemented in hardware. In another embodiment, the single feed-forward path is implemented in software.

In one exemplary implementation of the method 100, at least three sorted data sequences may be apportioned from memory into at least three first-in-first-out (FIFO) buffers such that each of the at least three FIFO buffers handles a corresponding sorted data sequence. A cascade of data processing stages may be used to merge the at least three sorted data sequences from the FIFO buffers into a single merged data sequence of sorted data values, where specifically the consecutive stages in the cascade of data processing stages are connected by a single feed-forward data path and output of each data processing stage in the cascade of data processing stages includes two or more data values in a sorted order. The single merged data sequence of sorted data values is then output to a downstream task.

At each time step, each of the at least three FIFO buffers may store a portion of the corresponding sorted data sequence. The portion of the corresponding sorted data sequence may be a vector of sorted data values such that at each timestep the at least three FIFO buffers store a plurality of vectors of sorted data values. In this regard, merging the at least three sorted data sequences from the FIFO buffers into the single merged data sequence of sorted data values may include, during each timestep, (a) selecting one of the plurality of vectors of sorted data values for being input to a first data processing stage in the cascade of data processing stages, where the selection is made by comparing a data value at a head of each vector of the plurality of vectors against a data value at a head of each other vector in the plurality of vectors and selecting the vector with a data value at its head that wins those comparisons as determined based on a defined order, and (b) transferring the selected vector of sorted data values from one of the FIFO buffers in which it is held to the first data processing stage such that the first data processing stage receives the selected vector of sorted data values as an input. In an embodiment, a further portion of the dataset may be apportioned from memory into the one of the FIFO buffers when the selected vector of sorted data values is transferred out of the one of the FIFO buffers (i.e. when space is made available in the FIFO buffer).

At the first data processing stage during a first subsequent timestep, (a) one of a plurality of locally stored vector of sorted data values may be selected for being merged with its received input, where the selection may be made by comparing a data value at a head of each locally stored vector of sorted data values of the plurality of locally stored vectors of sorted data values with a data value at a head of each other locally stored vector of sorted data values of the plurality of locally stored vectors of sorted data values and selecting the locally stored vector of sorted data values with a data value at its head that that wins those comparisons as determined based on a defined order, (b) the received input may be merged with the selected one of a plurality of locally stored vectors of sorted data values, and (c) a result of the merging may be output to a second data processing stage such that the second data processing stage receives the result of the merging performed at the first data processing stage as an input.

The second data processing stage proceeds by processing its input in the same manner as the first data processing stage during a second subsequent timestep. A result of the merging by the second data processing stage may be output to a third data processing stage such that the third data processing stage receives the result of the merging performed at the second data processing stage as an input.

This merging per data processing stage may be repeated until the last data processing stage outputs a single merged data sequence of sorted data values comprising all data values from the original dataset. The single merged data sequence of sorted data values may be output from the last data processing stage to a downstream task for further processing (e.g. for performing ray-tracing, database query processing, genomic analysis, signal processing, etc.).

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

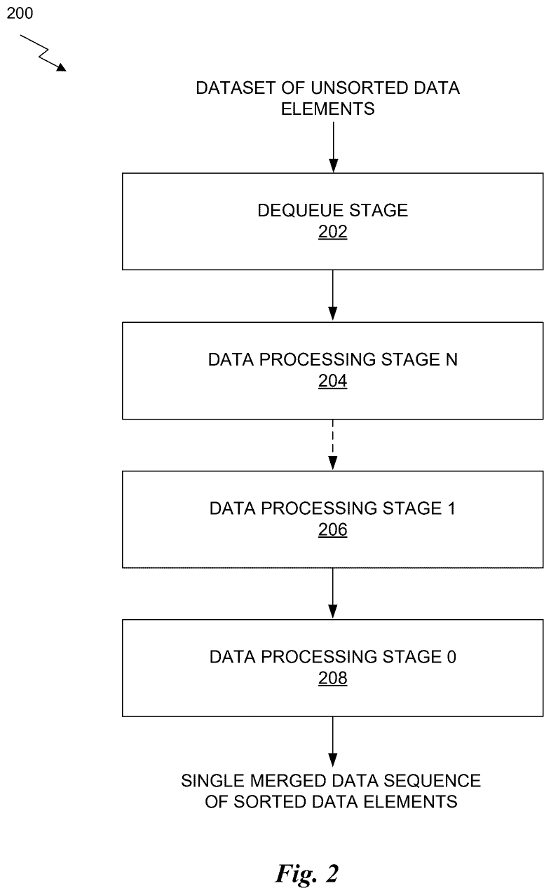

FIG. 2 illustrates pipeline architecture 200 for merging data that includes a single feed-forward data path between consecutive stages, in accordance with an embodiment. In an embodiment, the pipeline architecture 200 may be implemented to carry out the method 100 of FIG. 1. The definitions and descriptions given above may accordingly apply to the present description.

As shown, the pipeline architecture 200 includes a dequeue stage 202 which incrementally inputs at least three sorted data sequences to a cascade of data processing stages 204-208 connected via a single data path (e.g. channel, bus, etc.) to generate a single merged data sequence of sorted data values comprising all data values from the at least three sorted data sequences.

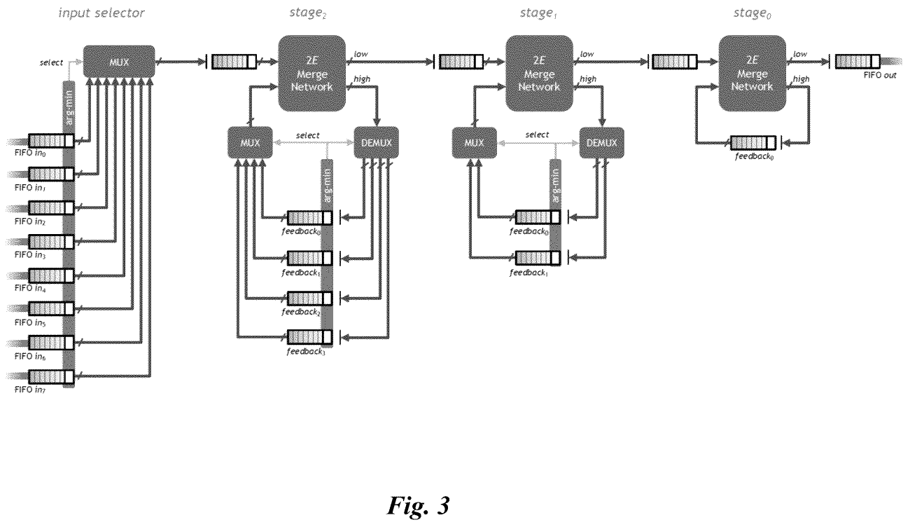

In an embodiment, the dequeue stage 202 may be decoupled from the data processing stages 204-208. For example, the dequeue stage 202 may be located in a memory system (e.g. the adjacent memory or cache hierarchy), whereas the data processing stages 204-208 may be located in at least one processing core. Locating the dequeue stage 202 in the memory system in which the at least three sorted data sequences are stored may eliminate latency associated with transferring the data elements to the dequeue stage 202, and thus can significantly reduce the critical latency for refilling input channels to the pipeline architecture 200. Locating the dequeue stage 202 in the memory system may also reduce other latency associated with the logic of the dequeue stage 202, as described with reference to FIG. 3 below.

In an embodiment, the data processing stages 204-208 may be located in a same processing core. In an embodiment, each data processing stage 204-208 may be implemented using a single merge unit, which may be a fixed network of binary comparators. For example, the data processing stages 204-208 may be multiplexed across the single merge unit. As another example, each data processing stage 204-208 may be implemented as a virtualized instance of the single merge unit. Use of a single merge unit for two or more data processing stages 204-208 can provide a high degree of utilization from a small hardware footprint, which benefits parallel merging scenarios. In another embodiment, the data processing elements 204-208 may each be located in a different processing core, each having a corresponding merge unit.

In any case, the data processing stages 204-208 are connected via the single data path. However, activities of consecutive data processing stages 204-208 may be oblivious to each other. The linear data flow between data processing stages 204-208 may be unaffected by distribution skew in the dataset, may have reduced channel overheads, and may further allow for the disaggregated staging. Further, the absence of inter-stage control dependences and channel multiplexing (1) can lead to drastically reduced implementation complexity, and (2) can allow for latency-tolerant interstage buffering, if desired. To this end, the pipeline architecture 200 may embody high levels of efficiency and skew tolerance.

During a merge process performed using the pipeline architecture 200, at least three sorted data sequences from the dequeue stage 202 are merged using the cascade of data processing stages that comprises the data processing stages 204-208 connected via the single feed-forward data path. During the merge process, output of each data processing stage 204-208 includes two or more data elements in a sorted order. A result of the merging is output is output by the pipeline architecture 200. The result may be output to a memory and/or to a downstream task.

It should be noted that the pipeline architecture 200 may be implemented as a standalone architecture that merges at least three sorted data sequences to generate the single merged data sequence of sorted data values, which may then be provided as input to the downstream task or made be made available in memory for access by the downstream task. In another implementation, the pipeline architecture 200 may be used as merge node within a larger PMT architecture.

FIG. 3 illustrates an exemplary implementation of the pipeline architecture 200 of FIG. 2, in accordance with an embodiment. The example shown is a logical 8-way, vector size 8 implementation of the pipeline architecture 200 which is comprised of one dequeue stage 202 and 3 data processing stages 204-208. In the present example, the pipeline architecture 200 merges 8 ascending-order input FIFO streams into one ascending-order output FIFO. The pipeline architecture 200 is pipelined and vectorized, consuming and producing one 8-element vector per pipeline timestep.

Of course, while in the present example the dequeue stage 202 is configured to include 8 vector inputs each configured to hold 8 data elements and the data processing stages 204-208 are numbered at 3 with each also processing and outputting 8-element vectors, this is only one possible implementation of the pipeline architecture 200 of FIG. 2. Other configurations of the pipeline architecture 200 are contemplated, and accordingly the description herein more generally refers to a K-way implementation for the pipeline architecture 200. Furthermore, any description herein that references merging and sorting based on ascending-order can equally be applied to any other defined order.

The K-way pipeline architecture 200 merges K ascending-order inputs into a single ascending-order output. The pipeline architecture 200 is vectorized, i.e., it produces E sorted elements per timestep. Moreover, the vector width is uniform throughout the pipeline architecture 200.

The dequeue stage 202 compares the head elements (also referred to herein as “keys”) of the input channels (i.e. FIFOs) and exclusively outputs, i.e., in each timestep, a single vector of E ordered data elements which is extracted from the input channel (i.e. FIFO) having the smallest key at its head. Consequently, up to (K−1)(E−1) non-head keys from previously dequeued vectors may be larger than the keys dequeued in the current timestep. To reconcile such inversions, vectors of ordered keys flow through a series of log₂K data processing stages 204-208 that collectively recirculate the (K−1)E largest keys seen so far. Each data processing stage 204-208 repeatedly merges its input vector with the one of its local feedback vectors having the smallest head element. From the resulting merged vector, the lower half is sent to the next data processing stage 204-208 and the upper half is recirculated as a local feedback vector.

In an embodiment, the data processing stage 204-208 are connected by a single, feed-forward channel that operates at a constant flowrate. In an embodiment, operations of the data processing stages 204-208 are independent. This permits disaggregated staging, i.e., the physical separation of data processing stage 204-208. In particular, the dequeue stage 202 can be implemented directly within the memory or last-level cache while the remainder of the pipeline architecture 200 resides in its own one or more processor cores. In this “decoupled selector” configuration, the pipeline architecture 200 timestep's critical path is dissociated from the long latency of memory because there are no flow-control dependences across the interconnect. Furthermore, the dequeue stage 202 requires significantly less internal buffering (if any) to prevent input channel exhaustion because it is co-located with the heads of the merge lists.

The independence of data processing stage 204-208 operations also simplifies pipeline-wide merge unit virtualization, i.e., the pipelining of all merging activities through a single (E,E)→2E merge unit that services the entire pipeline architecture 200. In an embodiment, this merge unit may be implemented as a fixed network of binary comparators, e.g., Batcher's bitonic or odd-even merge network. In another embodiment, multiple concurrent pipeline architecture 200 instances may be virtualized over the same hardware. The comparator networks needed for min-selection within each data processing stage 204-208 can be similarly virtualized and pipelined.

The pipeline architecture 200 can be implemented in hardware or software. It does not require the reservation of special sentinel values within the domain of data elements. It may be assumed, without loss of generality, that data elements (1) are machine words of some fixed bit length, (2) do not explicitly distinguish key and payload subfields, and (3) and are compared wholesale under some total order. If keys have payloads, key data must be more significant than payload data. If the application wants a stable merge, the pipeline architecture 200 can be extended to insert sufficient initial-rank bits between key and payload bitfields.

The following description discloses various embodiments of the operation of the components of the pipeline architecture 200. Table 1 lists notations and conventions used in the following description.

TABLE 1

| 1. | Zero-based subscript ₖ is used to index a specific merge network/unit (e.g., networkₖ) | |
|---|---|---|
| 2. | Bracketed subscript _{[t]} is used to denote contents at timestep t (e.g., vec_{[t]}) | |
| 3. | Let head(vec) denote the smallest (first) element of the vector vec | |
| 4. | Let tail(vec) denote the largest (last) element of the vector vec | |
| 5. | FIFO channels operate on first-in, first-out principle. They also convey: | |
| | a. | occupancy, i.e., number of items currently enqueued within the FIFO |

| | |
|---|---|
| i. | A FIFO is empty when its occupancy is zero |

| | |
|---|---|
| b. | {fill\|drain} status, i.e., whether the producer is done inserting elements into the |
| | FIFO |

| | |
|---|---|
| i. | A FIFO can only be considered end-of-stream when it is both empty and is |
| | in drain mode. Otherwise, the producer may simply be running slower |
| | than the consumer. |

The K-way pipeline architecture 200 features a single input selection logic that feeds a chain of ┌log₂(K)┐ data processing stages 204-208. Each interior data processing stage s 204-208 encapsulates at most 2^{s} feedback vectors. More precisely, each data processing stage 204-208 requires ┌Nₛ/2┐ feedback vectors, where Nₛ is the number of inputs to that stage 204-208. Each feedback vector comprises E elements, which are initialized as <MIN_VAL> prior to the first timestep. Stage interconnection FIFOs are initialized as empty.

At each timestep, the pipeline architecture 200 operates as follows:
1. The input selector logic inspects the first element of each input FIFO, dequeues a vector of E elements from the FIFO with the smallest head, and then sends that vector to the initial data processing stage 204. The selection logic will pad any partially full vectors with <MAX_VAL> elements. Similarly, it will treat the head of an empty FIFO as a vector of <MAX_VAL> elements. If the head elements of two input FIFOs both compare as <MAX_VAL>, yet one of the FIFOs is empty, selection preference will be given to the other FIFO.
2. Each data processing stage 204-208 inspects its input FIFO. If it is empty, the stage 204-208 stalls. Otherwise, the stage 204-208 dequeues a selection vector sel_vec and activates its feedback vector fb_veck having the smallest head element. It then performs a 2E merger of sel_vec and fb_veck, the result of which is split into two halves:
(A) The smallest E elements (lowk) are pushed to the output FIFO unless it is the first active timestep for fb_veck. Otherwise, the lowk vector is discarded, as it comprises the “dummy”<MIN_VAL> contents of fb_veck's initial feedback registers.
(B) The largest E elements (highk) are recirculated back into fb_veck.

The pipeline architecture 200 runs until its final stage 208 has emitted the same number of elements as the input selector has consumed from its input FIFOs. The final output vector of the merge will be padded with <MAX_VAL> elements if the number of valid inputs is not an exact multiple of E.

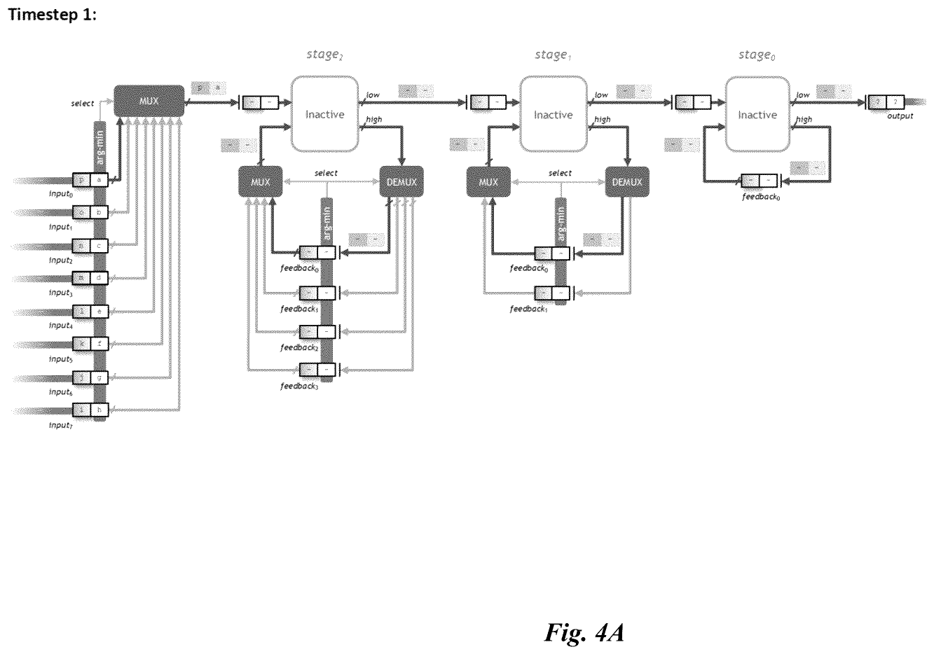

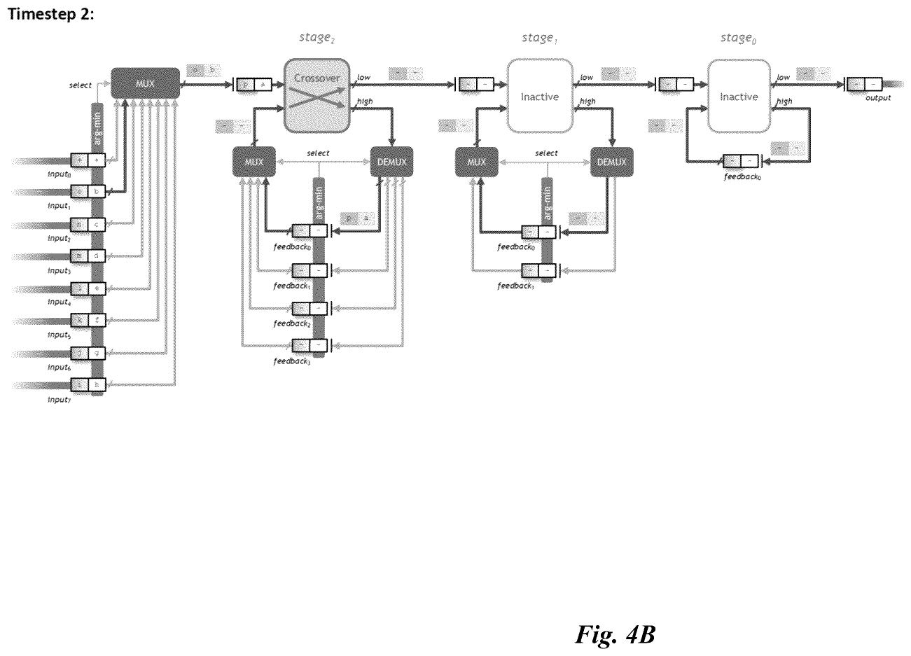

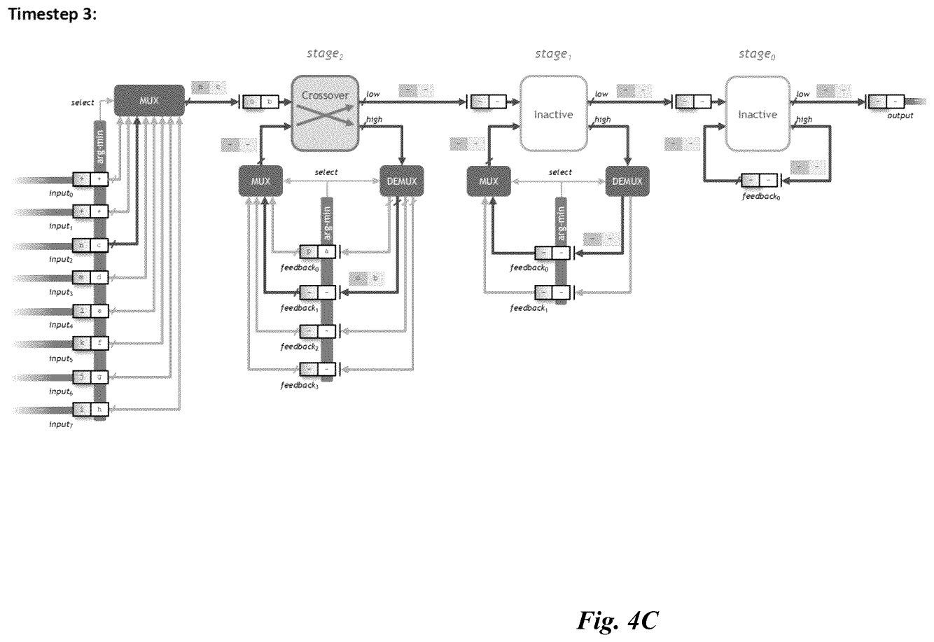

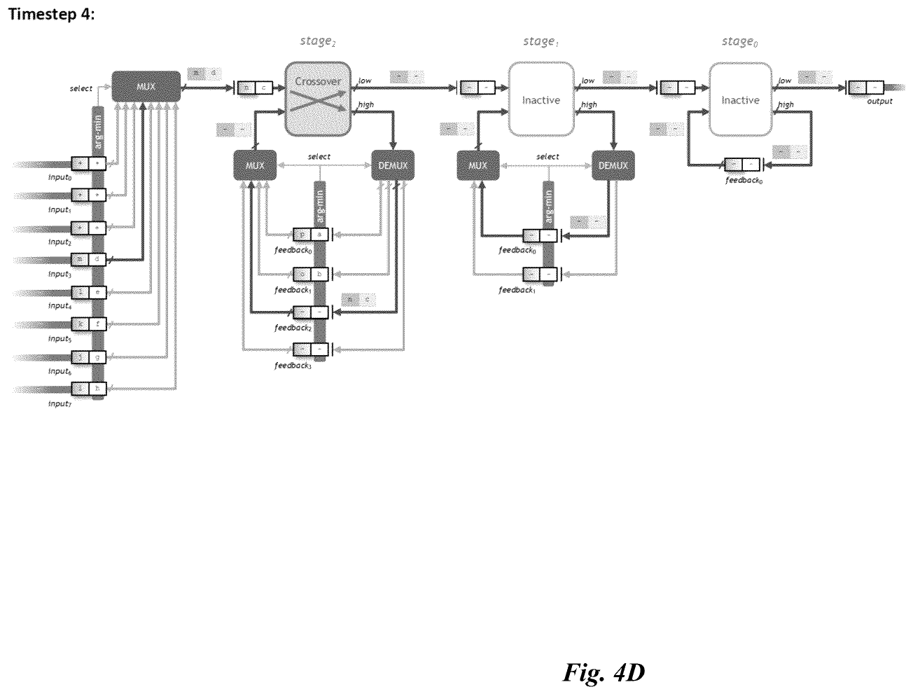

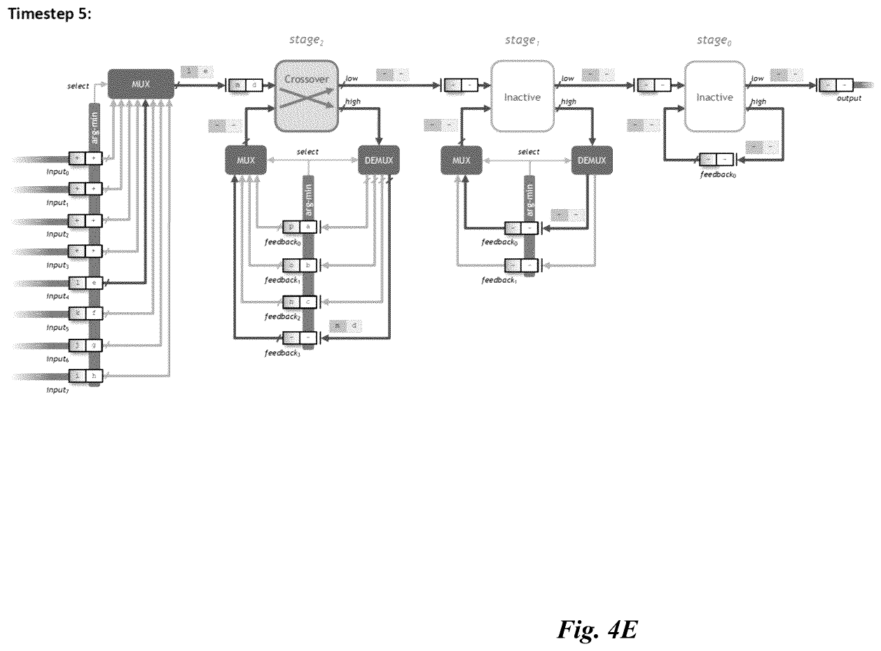

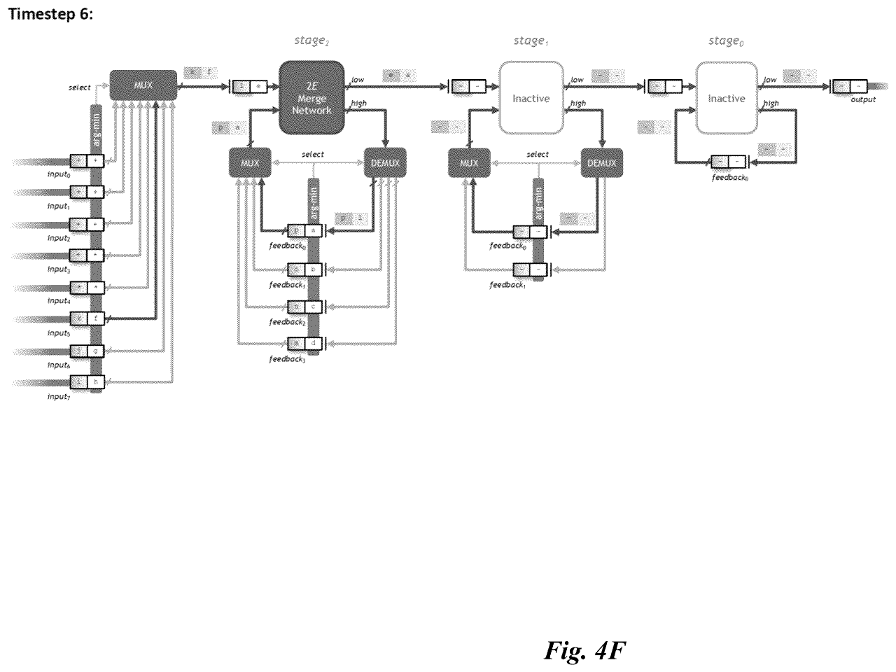

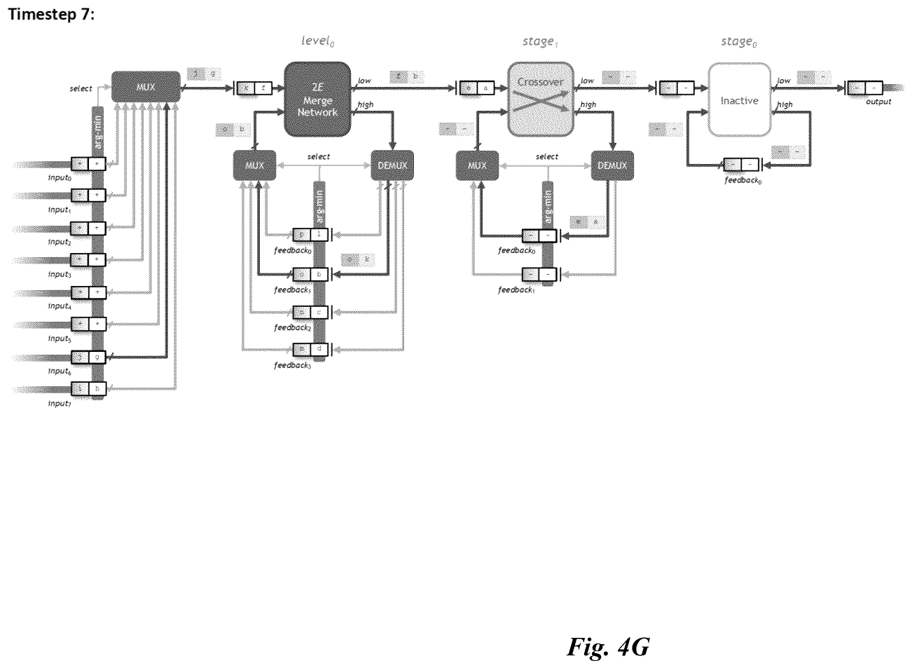

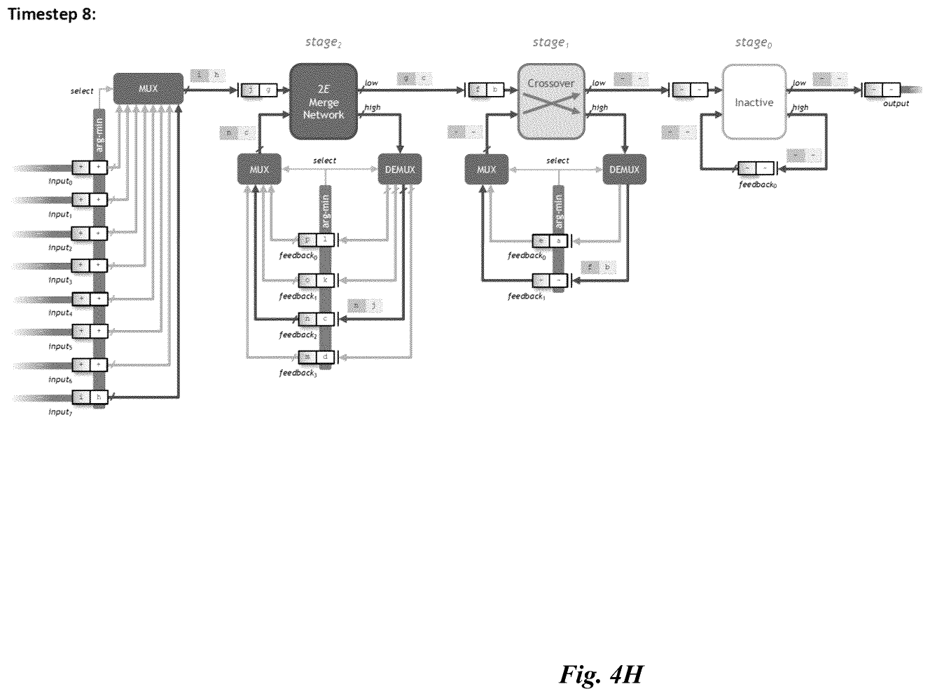

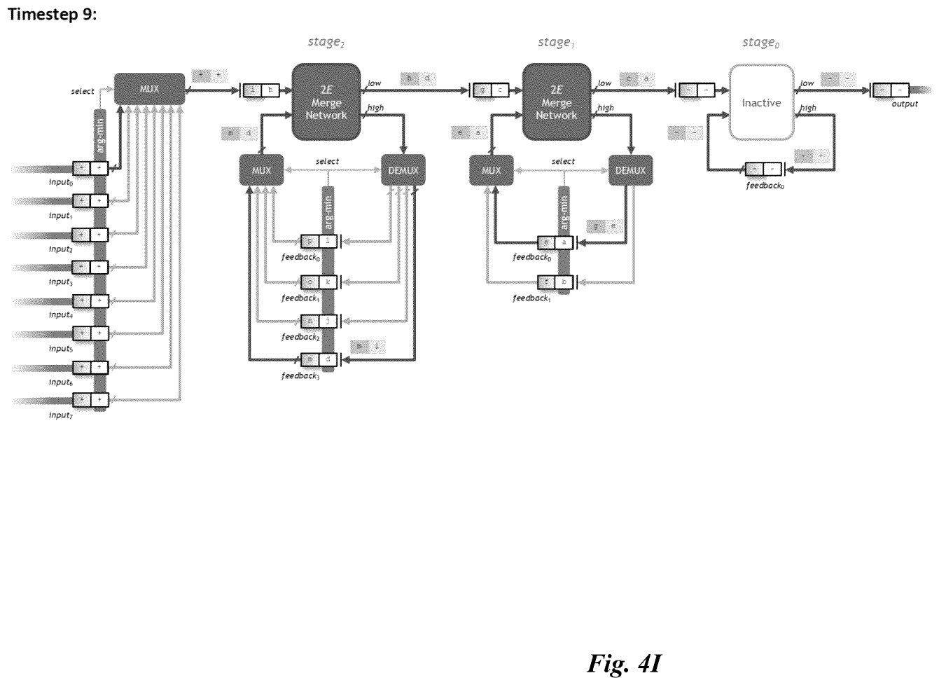

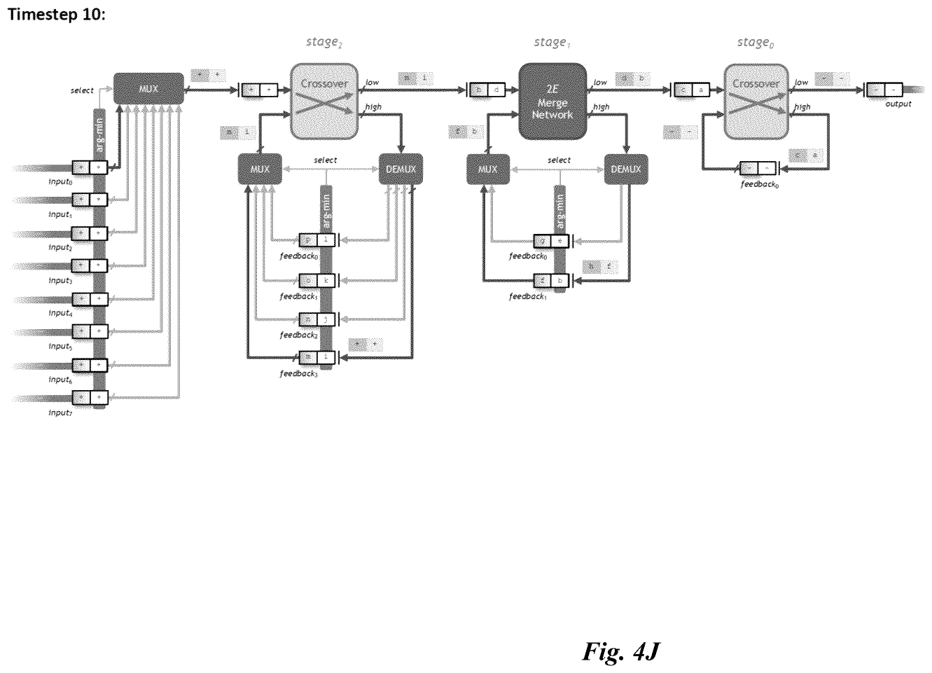

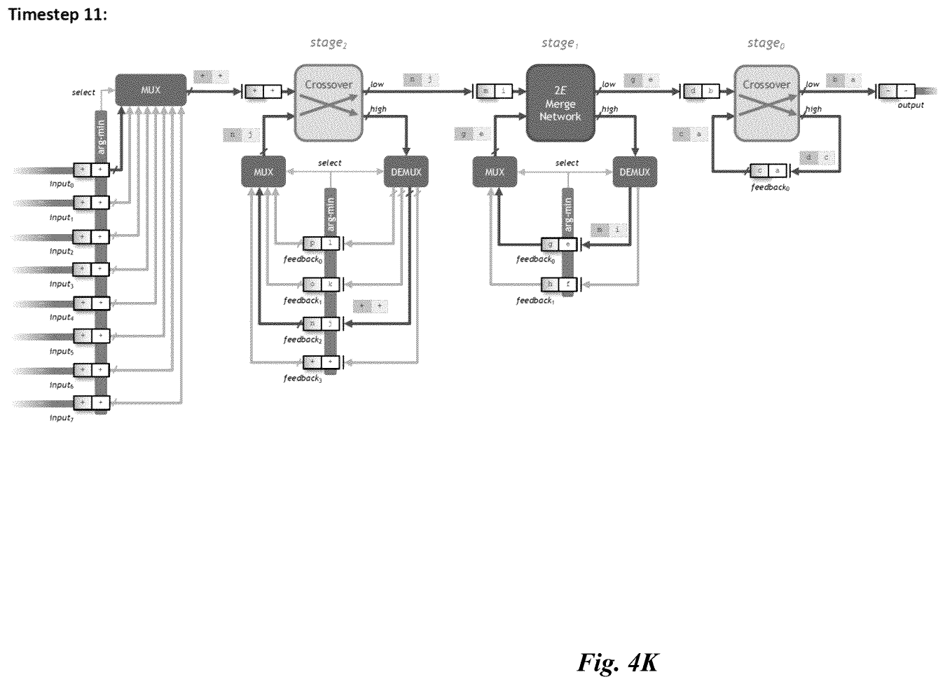

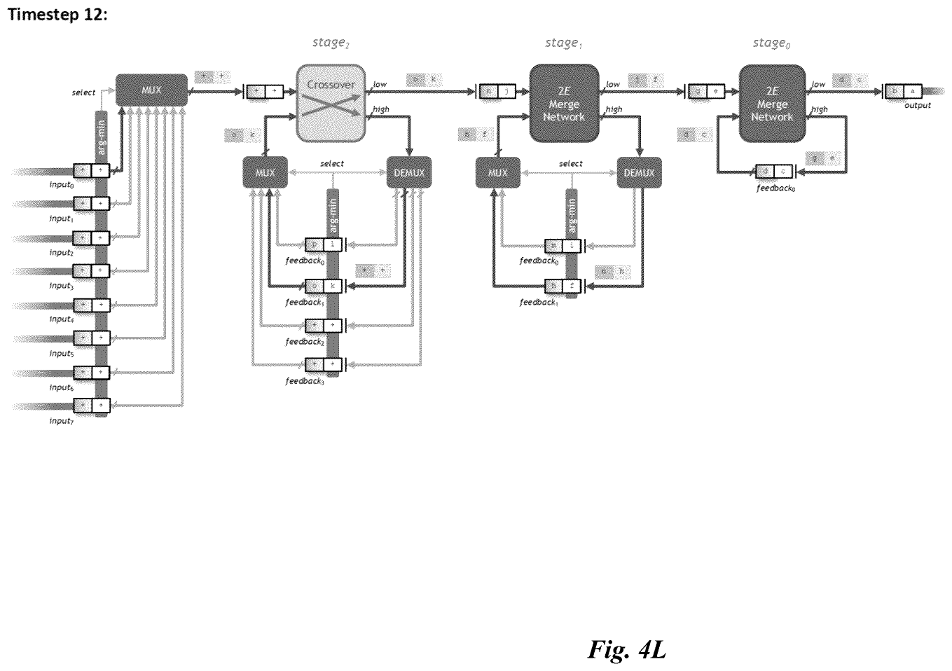

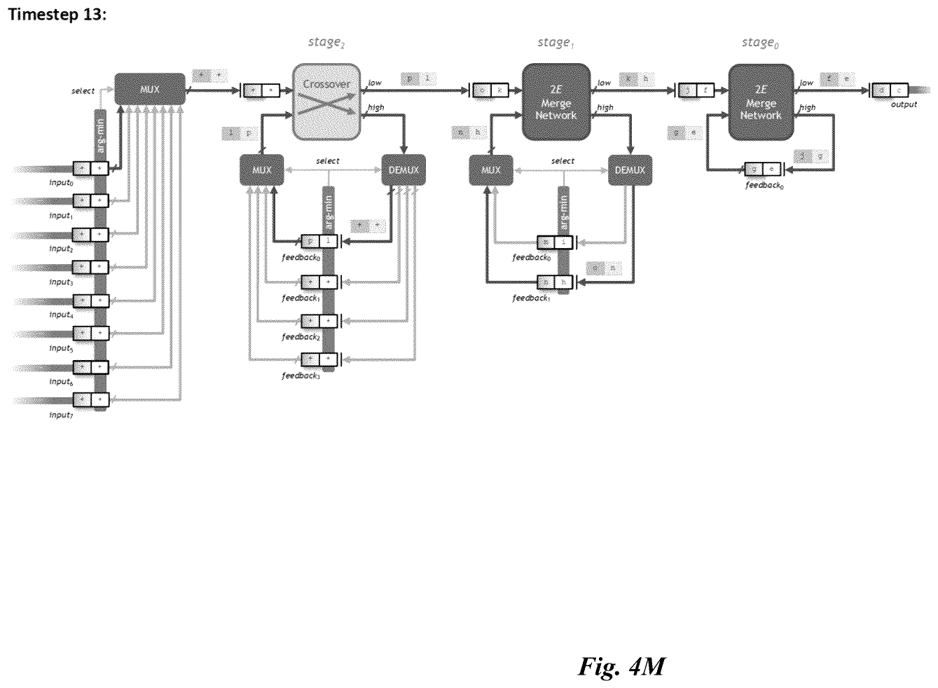

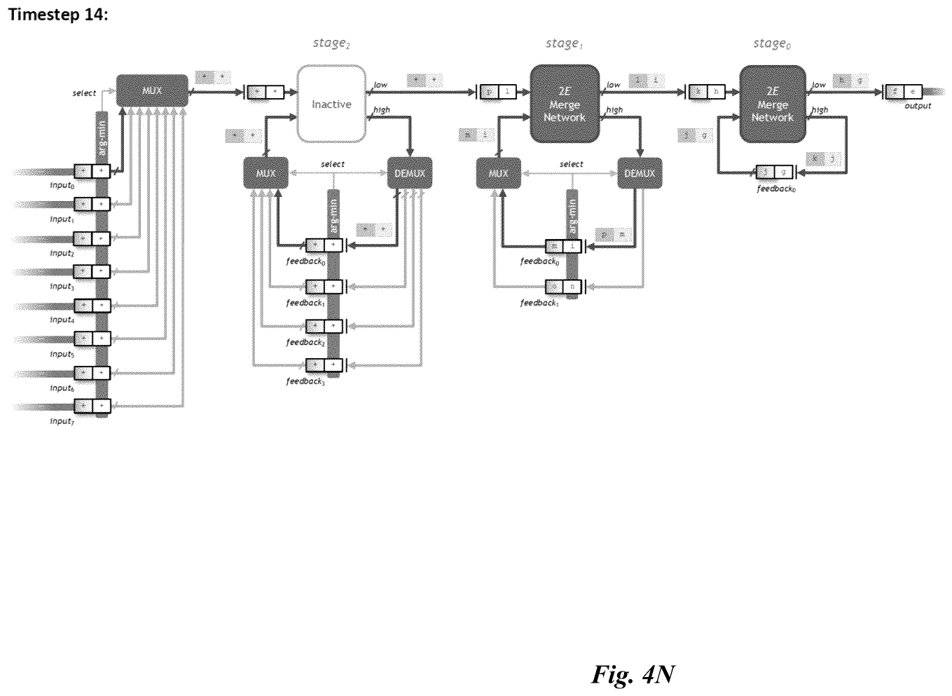

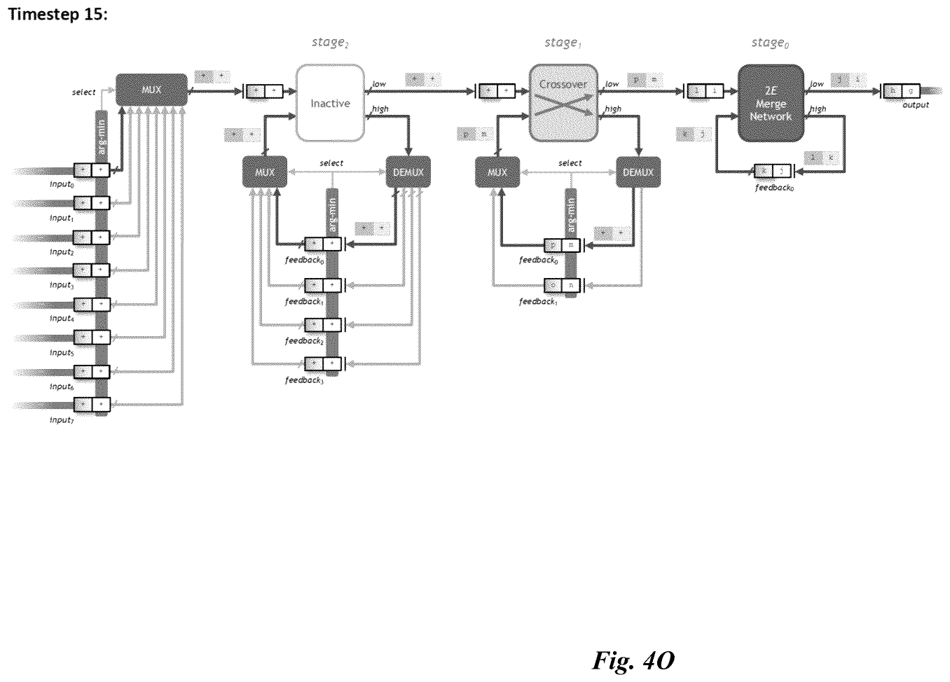

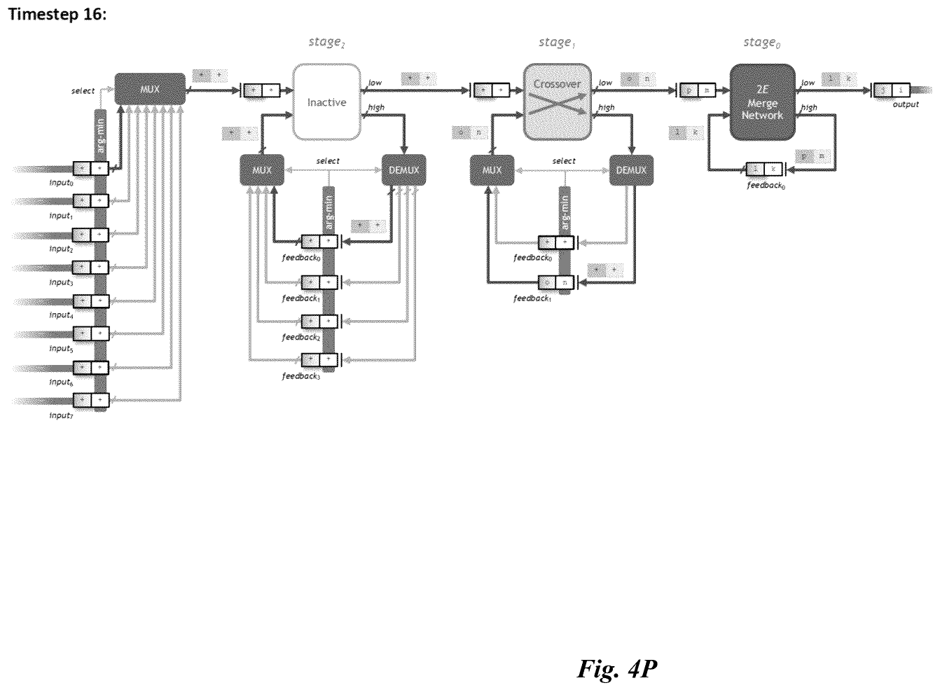

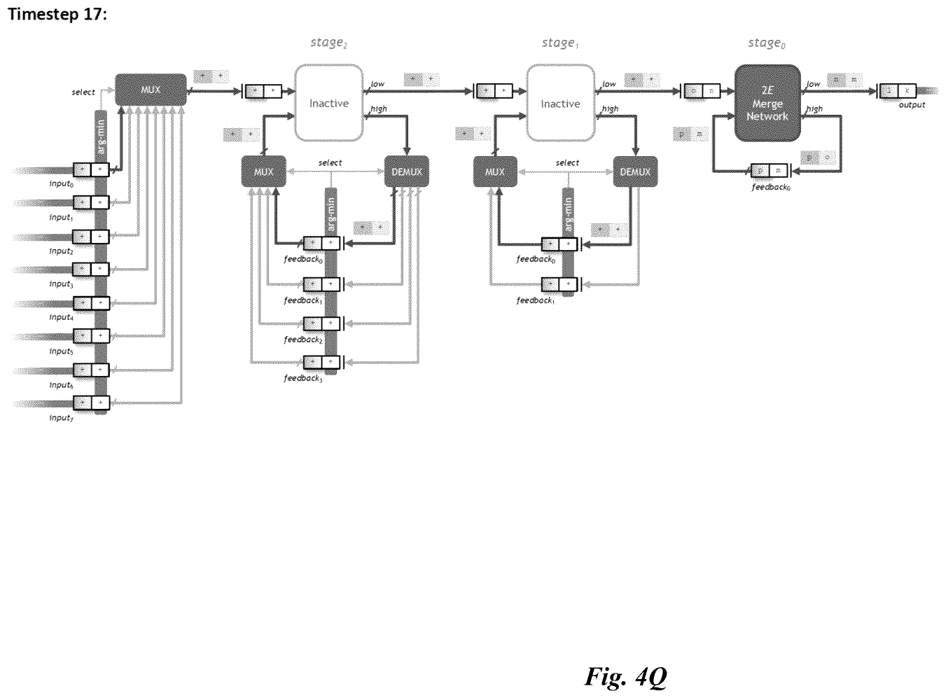

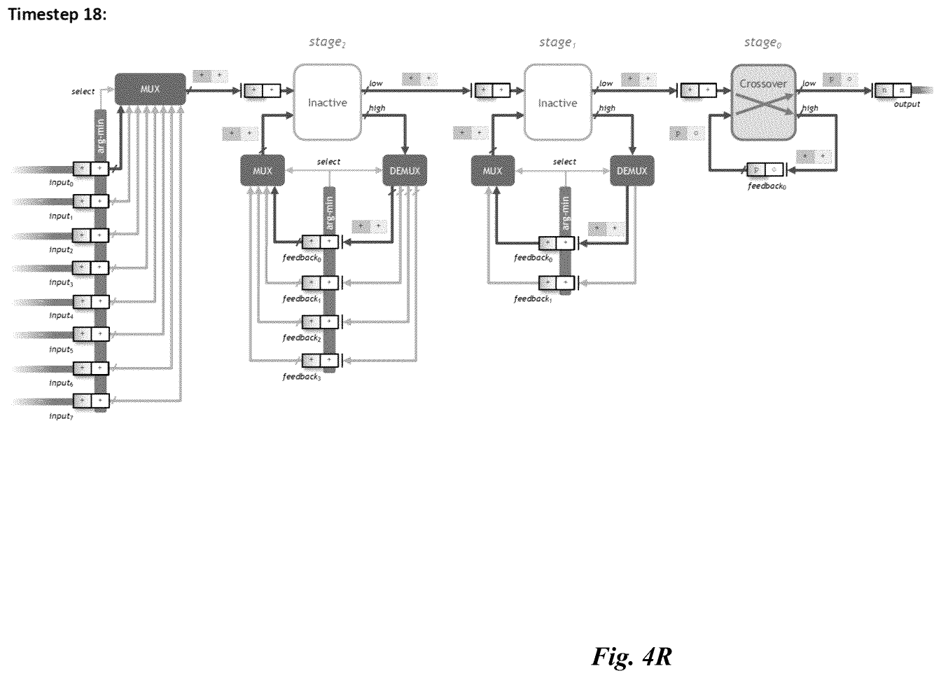

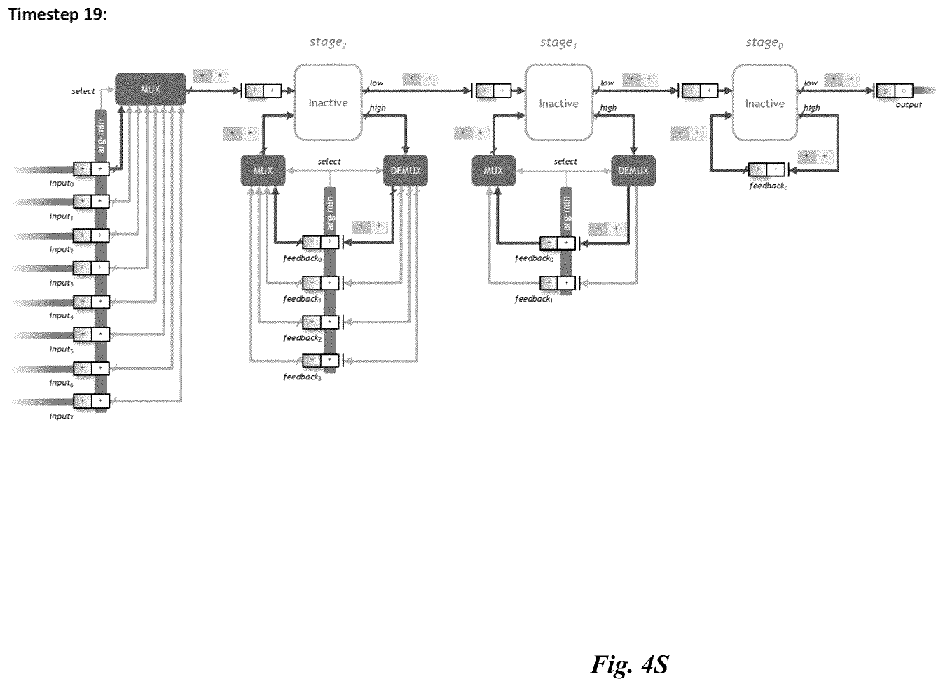

FIGS. 4A-4S illustrate a state of the pipeline architecture 200 of FIG. 2 during a merge process, in accordance with an embodiment. The pipeline architecture takes the form of the implementation shown in FIG. 3 but with employing a vector width E=2. The pipeline state is illustrated over 19 timesteps of the merge process.

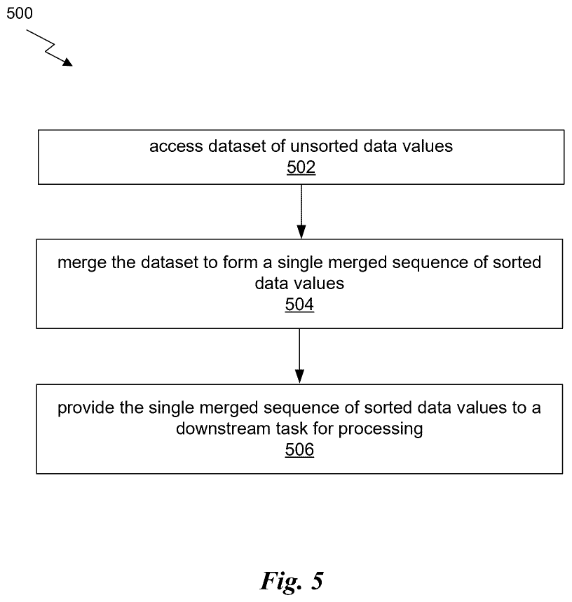

FIG. 5 illustrates a method 500 for merging data for use by a downstream task, in accordance with an embodiment. The method 500 may be carried out in the context of the any of the embodiments disclosed above.

In operation 502, a dataset of unsorted data values is accessed. The dataset may be accessed from a memory. The memory may be a local memory, for example. The dataset may be generated for processing by a particular downstream task. For example, where the downstream task is ray-tracing, the dataset may include data values representing elements of a scene. As another example, where the downstream task is signal processing, the dataset may include data values representing different signals.

In operation 504, the dataset is merged to form a single merged sequence of sorted data values. In the context of the present embodiment, operation 504 is carried out via the method 100 of FIG. 1. In particular, at least three sorted data sequences generated from the dataset are merged using a cascade of data processing stages, where consecutive stages in the cascade of data processing stages are connected by a single feed-forward data path and where output of each data processing stage in the cascade of data processing stages includes two or more data elements in a sorted order.

In operation 506, the single merged sequence of sorted data values is output to a downstream task for processing. In an embodiment, the single merged sequence of sorted data values may be streamed to the downstream task. In an embodiment, the single merged sequence of sorted data values may be output to a memory accessible to the downstream task such that the downstream task can retrieve the single merged sequence of sorted data values from the memory for processing. As mentioned above, the processing may include ray-tracing, signal processing, etc., just by way of example.

FIG. 6 illustrates a network architecture 600, in accordance with one possible embodiment. As shown, at least one network 602 is provided. In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 604 and an end user computer 606 may be coupled to the network 602 for communication purposes. Such end user computer 606 may include a desktop computer, lap-top computer, and/or any other type of logic. Still yet, various other devices may be coupled to the network 602 including a personal digital assistant (PDA) device 608, a mobile phone device 610, a television 612, a game console 614, a television set-top box 616, etc.

FIG. 7 illustrates an exemplary system 700, in accordance with one embodiment. As an option, the system 700 may be implemented in the context of any of the devices of the network architecture 600 of FIG. 6. Of course, the system 700 may be implemented in any desired environment.

As shown, a system 700 is provided including at least one central processor 701 which is connected to a communication bus 702. The system 700 also includes main memory 704 [e.g. random access memory (RAM), etc.]. The system 700 also includes a graphics processor 706 and optionally a display 708.

The system 700 may also include a secondary storage 710. The secondary storage 710 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 710, and/or any other memory, for that matter. Such computer programs, when executed, enable the system 700 to perform various functions (as set forth above, for example). Memory 704, storage 710 and/or any other storage are possible examples of non-transitory computer-readable media.

The system 700 may also include one or more communication modules 712. The communication module 712 may be operable to facilitate communication between the system 700 and one or more networks, and/or with one or more devices through a variety of possible standard or proprietary communication protocols (e.g. via Bluetooth, Near Field Communication (NFC), Cellular communication, etc.).

As also shown, the system 700 may optionally include one or more input devices 714. The input devices 714 may be wired or wireless input device. In various embodiments, each input device 714 may include a keyboard, touch pad, touch screen, game controller (e.g. to a game console), remote controller (e.g. to a set-top box or television), or any other device capable of being used by a user to provide input to the system 700.

As described herein, a method, computer readable medium, and system are disclosed to merge data using a single feed-forward data path between consecutive data processing stages. In accordance with FIGS. 1-5, embodiments may merge the data for further processing by a downstream task. The methods, programs, and systems may be implemented in the context of any of the devices depicted in FIGS. 6 and/or 7.

1. A method, comprising:
at a device:
apportioning at least three sorted data sequences from memory into at least three first-in-first-out (FIFO) buffers such that each of the at least three FIFO buffers handles a corresponding sorted data sequence;
using a cascade of data processing stages to merge the at least three sorted data sequences from the FIFO buffers into a single merged data sequence of sorted data values, wherein consecutive stages in the cascade of data processing stages are connected by a single feed-forward data path and wherein output of each data processing stage in the cascade of data processing stages includes two or more data values in a sorted order;
outputting the single merged data sequence of sorted data values to a downstream task.

2. The method of claim 1, wherein at each time step each of the at least three FIFO buffers stores a portion of the corresponding sorted data sequence.

3. The method of claim 2, wherein the portion of the corresponding sorted data sequence is a vector of sorted data values such that at each timestep the at least three FIFO buffers store a plurality of vectors of sorted data values.

4. The method of claim 3, wherein merging the at least three sorted data sequences from the FIFO buffers into the single merged data sequence of sorted data values includes, during each timestep:
selecting one of the plurality of vectors of sorted data values for being input to a first data processing stage in the cascade of data processing stages, wherein the selection is made by comparing a data value at a head of each vector of the plurality of vectors against a data value at a head of each other vector in the plurality of vectors and selecting the vector with a data value at its head that wins those comparisons as determined based on a defined order,
transferring the selected vector of sorted data values from one of the FIFO buffers in which it is held to the first data processing stage such that the first data processing stage receives the selected vector of sorted data values as an input.

5. The method of claim 4, wherein a further portion of one of the at least three sorted data sequences is apportioned from the memory into the one of the FIFO buffers when the selected vector of sorted data values is transferred out of the one of the FIFO buffers.

6. The method of claim 5, wherein merging the at least three sorted data sequences from the FIFO buffers into the single merged data sequence of sorted data values includes, at the first data processing stage during a first subsequent timestep:
selecting one of a plurality of locally stored sorted data sequences for being merged with the received input, wherein the selection is made by comparing a data value at a head of each locally stored sorted data sequence of the plurality of locally stored sorted data sequences with a data value at a head of each other locally stored sorted data sequence of the plurality of locally stored sorted data sequences and selecting the locally stored sorted data sequence with a data value at its head that that wins those comparisons as determined based on a defined order,
merging the received input with the selected one of a plurality of locally stored sorted data sequences, and
outputting a result of the merging to a second data processing stage such that the second data processing stage receives the result of the merging performed at the first data processing stage as an input.

7. The method of claim 6, wherein merging the at least three sorted data sequences from the FIFO buffers into the single merged data sequence of sorted data values includes, at the second data processing stage during a second subsequent timestep:
selecting one of a plurality of locally stored sorted data sequences for being merged with the received input, wherein the selection is made by comparing a data value at a head of each locally stored sorted data sequence of the plurality of locally stored sorted data sequences with a data value at a head of each other locally stored sorted data sequence of the plurality of locally stored sorted data sequences and selecting the locally stored sorted data sequence with a data value at its head that that wins those comparisons as determined based on a defined order,
merging the received input with the selected one of a plurality of locally stored sorted data sequences, and
outputting a result of the merging to a third data processing stage such that the third data processing stage receives the result of the merging performed at the second data processing stage as an input.

8. The method of claim 1, wherein the downstream task uses the single merged data sequence of sorted data values to perform ray-tracing.

9. The method of claim 1, wherein the downstream task uses the single merged data sequence of sorted data values to perform database query processing.

10. The method of claim 1, wherein the downstream task uses the single merged data sequence of sorted data values to perform genomic analysis.

11. The method of claim 1, wherein the downstream task uses the single merged data sequence of sorted data values to perform signal processing.

12. A method, comprising:
at a device:
merging at least three sorted data sequences using a cascade of data processing stages, wherein consecutive stages in the cascade of data processing stages are connected by a single feed-forward data path and wherein output of each data processing stage in the cascade of data processing stages includes two or more data elements in a sorted order; and
outputting a result of the merging.

13. The method of claim 12, wherein the merging is performed in accordance with a defined order.

14. The method of claim 13, wherein the defined order is one of:
an ascending order,
a descending order,
a customized ordering that is defined at the time the device is instantiated, or
a customized ordering that is defined at the time the device is invoked.

15. The method of claim 12, wherein the at least three sorted data sequences are held in a dequeue stage from which the at least three sorted data sequences are input to a first data processing stage in the cascade of data processing stages.

16. The method of claim 15, wherein the dequeue stage is decoupled from the cascade of data processing stages.

17. The method of claim 16, wherein the dequeue stage is located within a memory system, and wherein the cascade of data processing stages is located within at least one processing core.

18. The method of claim 17, wherein at least two data processing stages in the cascade of data processing stages are located within different processor cores.

19. The method of claim 17, wherein at least two data processing stages in the cascade of data processing stages are located within a same processor core.

20. The method of claim 15, wherein at each time step of at least a subset of all time steps during the merging, the dequeue stage inputs a different portion of one of the at least three sorted data sequences to a first data processing stage in the cascade of data processing stages.

21. The method of claim 20, wherein each different portion that is input to the first data processing stage is a vector of sorted data elements.

22. The method of claim 21, wherein the plurality of vectors of sorted data elements are stored in a plurality of first-in-first-out (FIFO) buffers of the dequeue stage.

23. The method of claim 22, wherein is the at least three sorted data sequences are apportioned from memory into the FIFO buffers as space in the FIFO buffers becomes available.

24. The method of claim 23, wherein at each time step of at least a subset of all time steps during the merging, one of the plurality of vectors of sorted data elements is selected for being input to the first data processing stage, wherein the selection is made by comparing a data element at a head of each vector of the plurality of vectors against a data element at a head of each other vector in the plurality of vectors and choosing the vector with a data element at its head that wins those comparisons based on a defined order.

25. The method of claim 12, wherein each data processing stage in the cascade of data processing stages merges a received input with a locally stored sorted data sequence and outputs a result.

26. The method of claim 25, wherein a first portion of the result is output forward through the single feed-forward data path and wherein a second portion of the result is stored locally by the data processing stage.

27. The method of claim 25, wherein each data processing stage in the cascade of data processing stages locally stores at least one sorted data sequence.

28. The method of claim 25, wherein at least the first data processing stage in the cascade of data processing stages selects the locally stored sorted data sequence from among a plurality of locally stored sorted data sequences.

29. The method of claim 28, wherein one of the plurality of locally stored sorted data sequences is selected for being merged with the received input, wherein the selection is made by comparing a data element at a head of each locally stored sorted data sequence of the plurality of locally stored sorted data sequences with a data element at a head of each other locally stored sorted data sequence of the plurality of locally stored sorted data sequences and choosing the one of the plurality of locally stored sorted data sequences with a data element at its head that wins those comparisons based on a defined order.

30. The method of claim 12, wherein the single feed-forward path operates at a constant flow rate.

31. The method of claim 12, wherein each data processing stage in the cascade of data processing stages is implemented using a single merge unit.

32. The method of claim 31, wherein the merge unit is a fixed network of binary comparators.

33. The method of claim 31, wherein each data processing stage in the cascade of data processing stages is implemented as a virtualized instance of the single merge unit.

34. The method of claim 12, wherein the single feed-forward path is implemented in hardware.

35. The method of claim 12, wherein the single feed-forward path is implemented in software.

36. The method of claim 12, wherein the result of the merging is a single sequence of data elements.

37. The method of claim 36, wherein the data elements in the single sequence of data elements are sorted data elements.

38. The method of claim 12, wherein the result of the merging is output to a downstream task.

39. The method of claim 38, wherein the downstream task uses the result of the merging to perform ray-tracing.

40. A system, comprising:
a non-transitory memory storing instructions; and
one or more processors in communication with the non-transitory memory, wherein the one or more processors execute the instructions to:
merge at least three sorted data sequences using a cascade of data processing stages, wherein consecutive stages in the cascade of data processing stages are connected by a single feed-forward data path and wherein output of each data processing stage in the cascade of data processing stages includes two or more data elements in a sorted order; and
output a result of the merging.

41. The system of claim 40, wherein the non-transitory memory further stores
a dataset of unsorted data elements, wherein the at least three sorted data sequences are generated from the dataset.

42. A system, comprising:
computer hardware that is configured to:
merge at least three sorted data sequences using a cascade of data processing stages, wherein consecutive stages in the cascade of data processing stages are connected by a single feed-forward data path and wherein output of each data processing stage in the cascade of data processing stages includes two or more data elements in a sorted order; and
output a result of the merging.

43. The system of claim 42, wherein the system further comprises a memory that stores a dataset of unsorted data elements, wherein the at least three sorted data sequences are generated from the dataset.

44. A non-transitory computer-readable media storing computer instructions which when executed by one or more processors of a device cause the device to:
merge at least three sorted data sequences using a cascade of data processing stages, wherein consecutive stages in the cascade of data processing stages are connected by a single feed-forward data path and wherein output of each data processing stage in the cascade of data processing stages includes two or more data elements in a sorted order; and
output a result of the merging.

45. The non-transitory computer-readable media of claim 44, wherein the result of the merging is output to a downstream task.

46. The non-transitory computer-readable media of claim 45, wherein the downstream task uses the result of the merging to perform ray-tracing.
